(19) United States
(12) Patent Application Publication
(10) Pub. No.: US 2007/0134978 A1
(43) Pub. Date: Jun. 14, 2007

(54) MAIN BOARD AND CONNECTOR WITH HIGH VOLTAGE PROTECTION

(76) Inventor: Chi-Pei Chin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,927

(22) Filed: Dec. 12, 2005

(51) Int. Cl. H01R 13/52

(52) U.S. Cl. 439/519

(57) ABSTRACT

A high-voltage proof main board and a connector, which is to prevent the damage caused by the high voltage from a transition line to the main board. The main board comprises a high voltage absorbing component, such as a diode and the connector comprise a plurality of electrical component and a plurality of line structure. The plurality of line structures is applied to electrically connect to plurality of electrical components. Additionally a predetermined distance is kept between each line structure and each electrical component. The high voltage protection a main board and a connector can reduce the manufacturing cost and the number of components and simplify the process of manufacturing to attain the objective of high voltage proof.

### BACKGROUND OF INVENTION

1. Field of the Invention

The present invention relates to a main board and connector thereof, and more particularly to a main board and connector with high voltage proof thereof.

2. Description of the Prior Art

With local network communication, computers on the line can easily communicate messages and data mutually for information communication. Users get on the line to upload or download data from an Internet server or other computers through local network line.

Though the local network communication provide convenience for the public, the computers coupled therewith may lose the data and have problems including files damaged, errors or breakdown when the local network is attacked by thunder or high voltage spikes caused by switches.

Accordingly, a chip is used to prevent thunder attack for the connector to connect to main board and Internet communication line and to prevent the main board from damaging by high voltage spikes. Referring to FIG. 1, it is a circuit diagram of the connector with the chip for prevent thunder attack. The connecting device 120 is usually provided for the network communication line 130 to connect main board 110. To avoid thunder attack or high voltage spikes caused by switches, the chip 150 for prevent thunder attack is provided on the side of the connecting device 120 that near the network communication line 130 so that high voltage spikes could not get into the main board 110 and damage the components thereon. However, it is required for advancement because the cost of such chips is expensive.

### SUMMARY OF THE INVENTION

The purpose of the present invention is to provide the connector with high voltage proof such as thunder attack or spikes caused by switches and to decrease the cost.

The another purpose of the present invention is to provide a main board with high voltage proof such as thunder attack or spikes caused by switches for cost reduction and simple manufacturing process.

Another purpose of the present invention is to provide a main board with high voltage proof such as thunder attack or spikes caused by switches with advantages of lower cost, simple manufacturing process and fewer components.

The connector with high voltage protection provided by the present invention is for connecting the main board with the communication line. The connector includes a plurality of electrical components and line structures wherein the plurality of line structures are used for connecting to the plurality of electrical components and each line structure is at least kept at a predetermined distance from ach electrical component. Furthermore the connector includes a converter, which includes a primary side coil electrically coupled to the communication line and a secondary side coil electrically coupled to the main board.

In an embodiment of the invention, the predetermined distance is greater than 3.75 mm and the primary side coil and the secondary side coil are coated with isolation material.

The main board with high voltage proof provided by the invention is electrically coupled to the communication line. The main board includes the connector, the converter and high voltage absorbing components wherein the connector includes a plurality of electrical components and line structures that each electrical component is at least kept at a predetermined distance from each line structure. The converter provided in the connector includes a primary side coil electrically to the communication line and secondary side coil, wherein the first side and second side of the secondary side coil are electrically coupled to the main board. And the high voltage absorbing components are electrically coupled between the first side and second side of the secondary side coil to absorb the high voltage transmitted by the communication line to the main board.

In an embodiment of the invention, the high voltage absorbing components are diodes and the primary side coil and secondary side coil are coated with isolation material.

The main board with high voltage protection provided by the invention is electrically coupled to the communication line. The main board includes the converter and the high voltage absorbing components wherein the converter includes the primary side coil electrically coupled to the communication line and the secondary side coil, wherein the first side and second side of the secondary side coil are electrically coupled to the main board. And the high voltage absorbing components are electrically coupled between the first side and second side of the secondary side coil to absorb the high voltage transmitted by the communication line to the main board.

In an embodiment of the invention, the high voltage absorbing components are diodes and the primary side coil and secondary side coil are coated with isolation material.

As described above, the connector with high voltage proof of the invention wherein each electrical component and each line structure are at least kept at a predetermined distance from each other so as to avoid high voltage transmitted from communication line to damage components in the main board. In addition, the connector of the invention could save the cost of the chip for preventing thunder attack used in the prior arts.

In another aspect, since the main board with high voltage proof of the invention includes the high voltage absorbing components so that other components inside the main board can not be damaged by high voltage from communication line. The high voltage absorbing components could use cheaper components such as diodes for cost reduction.

To easily and clearly understand the above and other purpose, features ad advantages of the invention, the preferred embodiments with attached drawings will be described below for detailed description.

### BRIEF DESCRIPTION OF DRAWINGS

FIG. 1 is a circuit diagram illustrating the connector with the thunder-proof chip.

FIG. 2 is a circuit diagram illustrating the main board of high-voltage proof according to an embodiment of the invention.

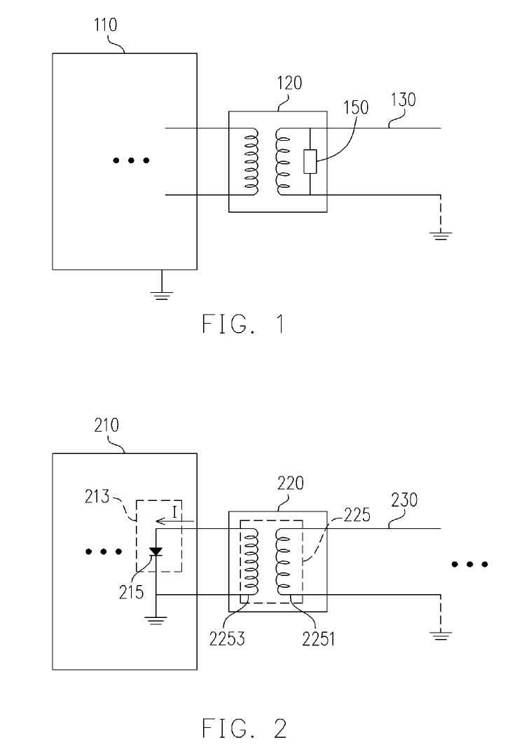

### THE PREFERRED EMBODIMENTS OF THE INVENTION

Referring to FIG. 2, a diagram of the main board of high-voltage proof according to an embodiment of the invention, the connector 220 is used to connect the main board 210 and the communication line 230, wherein the communication line 230 is a network communication line, for example.

It's well-known that the connector 220 includes a plurality of electrical components and line structures. Although the components in the connector 220 are not illustrated in detailed, the persons skilled in the art can understand the construction of the connector 220. Additionally, the connector 220 is disposed with a converter 225, which includes a primary side coil 2251 electrically coupled to the communication line 230 and a secondary side coil 2253 electrically coupled to the main board 210.

In the invention, to avoid thunder attack or high voltage spikes caused by switches to damage the components of the connector 220 and the main board 210, each line structure and each electrical component are at least kept a predetermined distance away from each other in the connector 220 provided by the invention. According to CE certification, a 4 KV high voltage could be avoided by a distance of 3.75 cm kept between two electrical components. Therefore, in the preferred embodiments, all distances between each line structure and each electrical components of the connector 220 are at least kept at 3.75 cm from each other.

Although the line structure and the electrical components of the connector 220 are kept at a predetermined distance from each other, the primary side coil 2251 and the secondary side coil 2253 of the converter 225 are twisted together. Accordingly, the distance between the line structure and the electrical components of the connector 220 both can not be enlarged to avoid for high high-voltage proof. For effectively preventing high voltage of the converter 225 from damaging the main board 210, the primary side coil 2251 and the secondary side coil 2253 are coated with isolation material in the embodiment so as to avoid prevent high voltage from the converter 225 damaging the main board 210.

In addition, the converter 225 features a high-pass filter. Accordingly, the feature of high pass filter of the converter 225, i.e. low frequency signals capable of isolating most high voltage spikes, can decrease the high voltage spikes coupled to the main board 210 when high voltages, such as thunder attack from the communication line 230 coupled to the main board 210. With this feature, the high voltage absorbing components 213 are electrically coupled to the two sides of the secondary side coil 2253 of the converter 225 in the invention so as to absorb energy of high frequency signal of high voltage spike coupled to the main board 210.

Since most energy of high voltage spikes is decreased when passing to the converter 225, the high voltage absorbing components 213 does not require expensive components. In the invention, the high voltage absorbing components 213 for example, could use the common diodes, such as diode 215. When high voltage spikes are coupled to the main board 210, the diode 215 is conducted. In the meantime, electric current produced by high voltage spikes stays at ground end by the diode 215 conduction so that the main board 210 can not be damaged by high voltage spikes and costs of expensive circuit cost can be saved.

As described above, the advantages of the main board and its connector with high voltage proof provided by the invention includes as follow:

Because each line structure and each electrical component in the connector are kept at least a predetermined distance from each other, high voltage spikes could be effectively prevented from entering into the main board.

Because the primary side coil and the secondary side coil of the converter are coated with isolation material, high voltage spikes could be effectively prevented from entering into the main board.

Because of using the common components such as diodes as the high voltage absorbing components, the circuit cost can be saved.

What is claimed is:

1. A connector with high voltage proof for connecting a main board to a communication line, comprising,
a plurality of electrical components, and
a plurality of line structures for electrically connecting to said electrical components, said line structures and said electrical components are kept at least a predetermined distance from each other.

2. The connector of claim 1, wherein said connector further comprises, a converter, which includes a primary side coil electrically coupled to said communication line and a secondary side coil electrically coupled to said main board.

3. The connector of claim 1, wherein said predetermined distance is greater than 3.75 cm.

4. The connector of claim 2, wherein said primary side coil is coated with the isolation material.

5. The connector of claim 2, wherein said secondary side coil is coated with the isolation material.

6. A main board with high voltage protection, which is coupled to a communication line, comprising,
a connector, which includes a plurality of electrical components and a plurality of line structures, wherein said line structures are used to electrically connect said electrical components and said each line structure and said each electrical component are kept at least a predetermine distance from each other,
a converter provided in said connector, which includes a primary side coil electrically coupled to said communication line and a secondary side coil, wherein a first side and a second side of said secondary side coil are electrically coupled to said main board, and
a high voltage absorbing component, which is electrically coupled between said first side and said second side of said secondary side coil to absorb high voltage energy transmitted from said communication line to said main board.

7. The main board of claim 6, wherein said high voltage absorbing component is a diode.

8. The main board of claim 6, wherein said primary side coil is coated with the isolation material.

9. The main board of claim 2, wherein said secondary side coil is coated with the isolation material.

10. A main board with high voltage protection, which is electrically coupled to communication line, comprising,
a converter, which includes a primary side coil electrically coupled to said communication line and a secondary side coil, wherein a first side and a second side of said secondary side coil are electrically coupled to said main board, and
a high voltage absorbing component, which is electrically coupled between said first side and said second side of said secondary side coil to absorb high voltage energy transmitted from said communication line to said main board.

11. The main board of claim 10, wherein said high voltage absorbing component is a diode.

12. The main board of claim 10, wherein said primary side coil is coated with the isolation material.

13. The main board of claim 10, wherein said secondary side coil is coated with the isolation material.
